(19) United States
(12) Patent Application Publication
(10) Pub. No.: US 2025/0215672 A1
(43) Pub. Date: Jul. 3, 2025

(54) FAUCET WITH MULTIPLE PARALLEL PIVOTS

(71) Applicant: Kohler Co., Kohler, WI (US)

(72) Inventors: Jacob R. Frye, Sheboygan Falls, WI (US); Margaret Cecile Mazz, Atlanta, GA (US); Matthew Tyler Harrison, Sheboygan, WI (US); Gary N. Clarke, Sheboygan, WI (US); Azzar Sidoney Bubb, Atlanta, GA (US); Paul B. Georgeson, Milwaukee, WI (US); Steven Thomas Radder, Kiel, WI (US)

(21) Appl. No.: 18/972,335

(22) Filed: Dec. 6, 2024

Related U.S. Application Data
(60) Provisional application No. 63/615,609, filed on Dec. 28, 2023.

(51) Int. Cl. E03C 1/04

(52) U.S. Cl. CPC E03C 1/0404

(57) ABSTRACT

The present application relates generally to faucets. More specifically, this application relates to directionally adjustable faucets, where at least two parallel rotational interfaces between components allow the faucet to pivot, rotate, spin, or move. A directionally adjustable primary or beverage faucet can include a first base section coupled to a second base section, a base rotational interface disposed between the first and second base sections along a first plane, a plurality of conduit segments coupled to the second base section, and at least one conduit rotational interface disposed between the plurality of conduit segments along a second plane. The base rotational interface can be configured to actuate the second base section relative to the first base section. The at least one conduit rotational interface can be configured to actuate the plurality of conduit segments relative to each other. The second plane can be parallel with the first plane.

### RELATED APPLICATIONS

The present disclosure claims to the benefit of U.S. Provisional Application Ser. No. 63/615,609, filed Dec. 28, 2023, which is hereby fully incorporated by reference in its entirety.

### TECHNICAL FIELD

The present application relates generally to faucets. More specifically, this application relates to directionally adjustable faucets, where at least two parallel rotational interfaces between components allow the faucet to pivot, rotate, spin, or move.

### BACKGROUND

Plumbing fixtures such as faucets and soap dispensers can include mechanical joints that allow a spout of the plumbing fixture to be adjustably positioned. However, some of these mechanical joints can be costly to manufacture and more susceptible to damage. In addition, the complexity of some mechanical joints can make the plumbing fixture more difficult to use and adjust. Further still, some mechanical joints are bulky and may be considered unaesthetically pleasing.

### SUMMARY

One example of the present application relates to a directionally adjustable faucet. The adjustable faucet can include a first base section and a second base section. The first base section and second base section are connected by a base rotational interface and a plurality of conduit segments are fluidly connected to the second base section. At least one conduit rotational interface is disposed between the plurality of conduit segments. The base rotational interface and at least one conduit rotational interfaces are oriented to be on parallel planes as each other.

In another example, a directionally adjustable faucet is disclosed as having a base section and an outlet portion fluidly connected to the base section. A plurality of conduit segments is fluidly attached to the outlet portion and a first rotational interface is disposed between the outlet portion and the plurality of conduit segments. A second rotational interface is disposed between the plurality of conduit segments. The first rotational interface and second rotational interface are oriented to be on parallel planes as each other.

In another example, a directionally adjustable primary or beverage faucet can include a first base section, a second base section couplable to the first base section, a base rotational interface disposable between the first base section and the second base section along a first plane, a plurality of conduit segments couplable to the second base section, and at least one conduit rotational interface disposable between the plurality of conduit segments along a second plane. The base rotational interface can be configured to actuate the second base section relative to the first base section. The at least one conduit rotational interface can be configured to actuate the plurality of conduit segments relative to each other. The second plane can be parallel with the first plane.

In examples, the plurality of conduit segments can include two conduit segments and the at least one conduit rotational interface can include one conduit rotational interface disposable between the two conduit segments. In examples, the plurality of conduit segments can be couplable to the second base section at a substantially right angle. In examples, the first base section and the second base section can have the same or substantially the same cross-sectional shape and area. In examples, the second base section can further include a fluid control knob configured to control fluid flow from the faucet. In examples, the first base section can be couplable to a surface and the first plane can be parallel to the surface. In examples, the first base section can be couplable to a surface and the first plane is perpendicular to the surface.

In examples, the plurality of conduit segments can include a first conduit segment and a second conduit segment. The first conduit segment can be couplable to a first fluid control knob and the second conduit segment can be couplable to a second fluid control knob. The first fluid control knob and the second fluid control knob can each be configured to control fluid flow from the faucet. In examples, the faucet may further include a pull-down sprayer couplable to the plurality of conduit segments. In examples, the first base section can be couplable to a mounting plate.

In another example, a directionally adjustable primary or beverage faucet can include a base section, an outlet portion couplable to the base section, a plurality of conduit segments couplable to the outlet portion, a first rotational interface disposable between the outlet portion and the plurality of conduit segments along a first plane, and a second rotational interface disposable between the plurality of conduit segments along a second plane. The first rotational interface can be configured to actuate the plurality of conduit segments relative to the base section. The second rotational interface can be configured to actuate the plurality of conduit segments relative to each other. The second plane can be parallel with the first plane.

In examples, the outlet portion can be couplable to the base section at a substantially right angle. In examples, the base section can be couplable to a mounting plate. In examples, the outlet portion and the plurality of conduit segments can have the same or substantially the same cross-sectional shape and area. In examples, the base section can further include a fluid control knob configured to control fluid flow from the faucet. In examples, the faucet can further include two fluid control knobs couplable to the plurality of conduit segments, the two fluid control knobs configured to control fluid flow from the faucet.

In another example, a directionally adjustable primary or beverage faucet can include a first base section couplable to a second base section, and a plurality of conduit segments couplable to the second base section. The second base section can be configured to actuate relative to the first base section. The plurality of conduit segments can be configured to actuate relative to each other.

### BRIEF DESCRIPTION OF THE DRAWINGS

The disclosure may be more completely understood in consideration of the following detailed description of examples of the disclosure in connection with the accompanying drawing, in which:

FIG. 1 is a perspective view of a single handle faucet with side spray;

FIG. 2 is a perspective view of the single handle faucet with side spray of FIG. 1 according to another example;

FIG. 3 is a perspective view of a surface-mounted pot filler;

FIG. 4 is a perspective view of a wall-mounted pot filler;

FIG. 5 is a perspective view of a single handle faucet according to another example; and

FIG. 6 is a perspective view of a single handle faucet according to another example.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Referring generally to the FIGURES, disclosed herein are various examples of adjustable plumbing fixtures that can be utilized to permit relative rotational movement between components. The adjustable plumbing fixtures disclosed herein have components that allow rotational movement at multiple rotational interfaces on parallel planes. This design provides an intuitive and user-friendly fixture, where the position of a spout and other components can be adjusted by moving the fixture within one plane of motion. The parallel rotational interfaces reduce resistance a user might otherwise encounter and allow for a smooth adjustment of the fixture. Further, the rotational interfaces allow for a sleek connection between conduit segments to allow for a wide range of motion without the bulky look and feel of large rotational joints that have a larger diameter than the conduit segments.

For example, a first rotational interface can allow a spout to swivel from a first position to a second position to dispense water where a user wants it. A second rotational interface located on a different segment can allow an extended range when needed, while rotating to be flat against the wall, for example, when not needed. This provides a benefit, among others, of allowing a user to fill large containers outside the sink, while maintaining a space efficient design when the extra range is not needed. A user may wish to do this, for example, to fill a large container that may not fit in the sink, to fill a pot on a stove, or to fill a container on the floor that may be too heavy to lift from sink-height once full. When the additional range is no longer needed, the multiple parallel rotational interfaces allow a portion of the faucet to be positioned away from the normally used area.

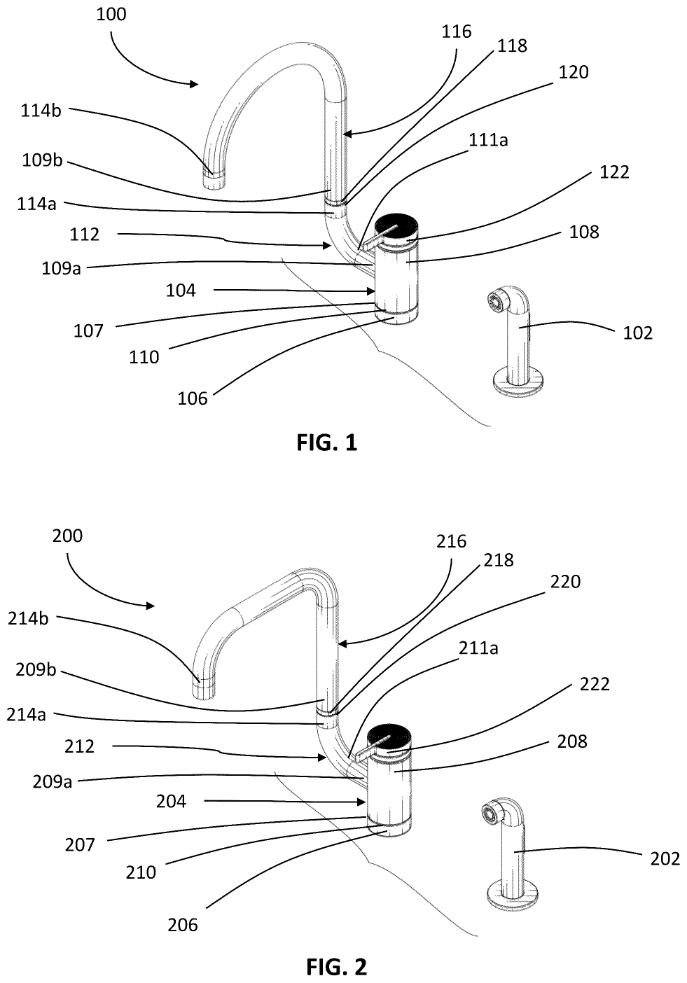

Referring now to FIGS. 1 and 2, an adjustable plumbing fixture is shown as a single handle faucet with side spray 100, 200. The faucets in FIGS. 1 and 2 operate similarly, and mainly differ in shape. One user may prefer the aesthetics of the overall rounded faucet of FIG. 1 while another user may prefer the more angular shape of the faucet in FIG. 2. Additionally, the example of FIG. 1 or FIG. 2 may be preferred for ease of manufacturing. For example, the straighter components of FIG. 2 may be more easily and cheaply manufactured.

The single handle faucet 100, 200 has a base section 104, 204 configured to be in fluid communication with a water line and mount to a surface, like a counter, sink, or wall, such that the base section 104, 204 extends substantially perpendicular from the surface. In other examples, a mounting plate can mount to the surface and the base section 104, 204 can extend substantially perpendicular from the mounting plate. The base section 104, 204 is split into a first base section 106, 206 and a second base section 108, 208. The second base section 108, 208 can have a fluid control knob 122, 222 positioned on top. The fluid control knob 122, 222 is configured to remain stationary when the second base section 108, 208 rotates, as discussed below.

The first base section 106, 206 and the second base section 108, 208 are fluidly connected by a base rotational interface 110, 210. The base rotational interface 110, 210 allows the second base section 108, 208 to rotate, spin, or otherwise move, relative to the first base section 106, 206, while allowing the first base section 106, 206 and second base section 108, 208 to remain fluidly connected to each other. Further, the base rotational interface 110, 210 defines a first plane 107, 207. In one example, the base rotational interface 110, 210 does not exceed the width or diameter of the base section 104, 204.

A first conduit segment 112, 212, having a first end 109a, 209a, a body 111a, 211a, and a second end 114a, 214a is fluidly attached to the second base section 108, 208 at the first end 109a, 209a. In an example, the body 111a, 211a extends substantially perpendicular from the second base section 108, 208, however, other examples can have the body 111a, 211a extend outwards from the second base section 108, 208 at nearly any angle. The second end 114a, 214a fluidly connects to a first end 109b, 209b of a second conduit segment 116, 216, thereby defining a conduit rotational interface 118, 218 between the second end 114a, 214a and first end 109b, 209b. The conduit rotational interface 118, 218 is situated along a second plane 120, 220, which is parallel to the first plane 107, 207. In an example, the first plane 107, 207 and second plane 120, 220 are also parallel to the mounting surface. In alternative examples, the first plane 107, 207 and second plane 120, 220 are perpendicular to the mounting surface.

In an example, the second end 114b, 214b of the second conduit segment 116, 216 comprises a spout. In other examples, the second end 114b, 214b of the second conduit segment 116, 216 attaches to a spout to provide further water dispensing options. For example, the second end 114b, 214b of the second conduit segment 116, 216 could be fluidly attached to a multi-mode spout or to a pull-down spout to allow even more flexibility in use. In the examples shown in FIGS. 1 and 2, the second end 114b, 214b of the second conduit segment 116, 216 comprises a spout, and a side spray faucet 102, 202 is configured to be mounted adjacent the faucet 100, 200.

In some examples, the bodies 111a, 211a and 111b, 211b can be comprised of multiple body pieces fluidly connected to each other through any method of water-tight connecting, such as threads, for example. Such a design may be desirable for manufacturability, such that curved and straight body pieces can be manufactured separately and later assembled together. In other examples, the bodies 111a, 211a and 111b, 211b can be comprised of a single body piece. Such a design may be desirable, for example, for certain aesthetic benefits. Further, the bodies 111a, 211a and 111b, 211b can be comprised of any length or curvature to reach the desired range of motion. In an example where the bodies 111a, 211a and 111b, 211b are comprised of multiple body pieces, it may be advantageous to allow a user to purchase additional or custom body pieces to create the desired range of motion in their personal space.

In an exemplary use, a user can place a pot in the sink or on the counter, stove, or floor. The user can pull or push the first conduit segment 112, 212 which would cause the faucet to rotate, spin, or move around the first rotational interface 110, 210. Further adjustment of the range of motion can be achieved by pulling or pushing on the second conduit segment 116, 216. This would cause the second conduit segment 116, 216 to rotate, spin, or move around the second rotational interface 118, 218 and further increase the range of motion. Alternatively, a user could only pull the second conduit segment 116, 216, which would cause simultaneous rotation around the first rotational interface 110, 210 and second rotational interface 118, 218. Such a use would allow for a quick and smooth extension of the faucet's range of motion to bring the spout over the pot. Once the spout is over the pot, the fluid control knob 122, 222 can be activated to fill the pot. After the pot is filled, the fluid control knob 122, 222 can be manipulated to stop the flow of water. The dual rotational interfaces would then allow the first and second conduit segments to be positioned flat against a wall, or elsewhere out of the way, when the faucet 100, 200 is no longer needed.

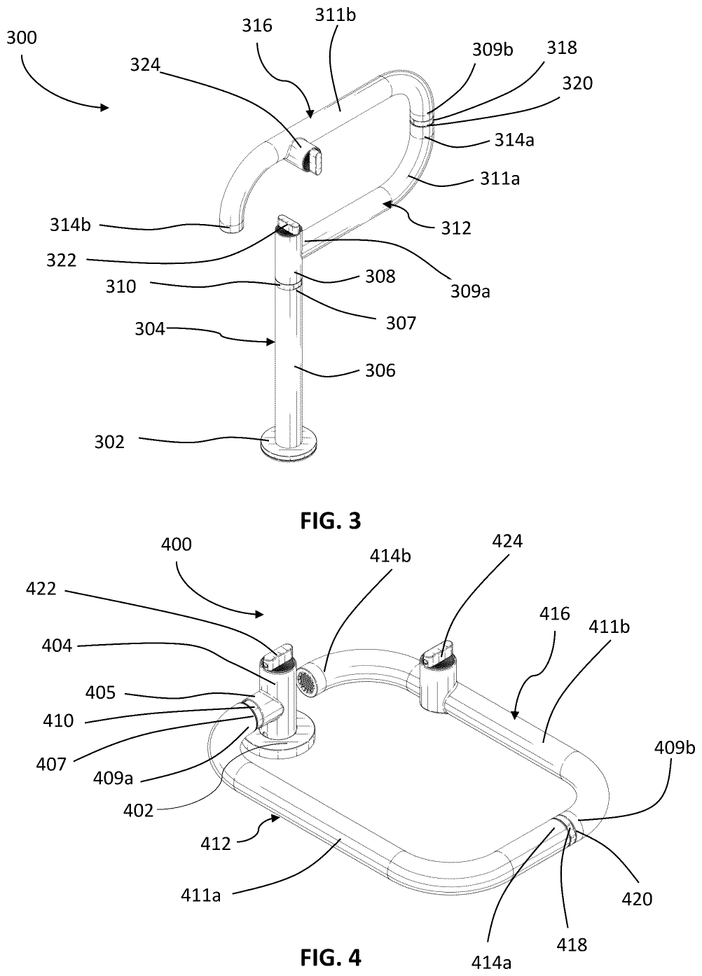

Referring now to FIG. 3, an adjustable plumbing fixture is shown as a free-standing pot filler 300. The pot filler 300 has a mounting plate 302 configured to be mounted to a surface like a sink or counter such that the pot filler is in fluid communication with a water line. A base section 304 extends substantially perpendicular from the mounting plate 302. In some examples, the base section 304 can extend directly from the sink or counter, and the base mounting plate 303 can be omitted. The base section 304 is split into a first base section 306 and a second base section 308. In some examples, a first fluid control knob 322 can be disposed on top of the second base section 308. The first fluid control knob 322 is configured to remain stationary when the second base section 308 rotates, as discussed below.

The first base section 306 and the second base section 308 are fluidly connected by a base rotational interface 310. The base rotational interface 310 allows the second base section 308 to rotate, spin, or otherwise move, relative to the first base section 306, while allowing the first base section 306 and second base section 308 to remain fluidly connected to each other. Further, the base rotational interface 310 defines a first plane 307. In one example, the base rotational interface 310 does not exceed the width or diameter of the base section 304.

A first conduit segment 312, having a first end 309a, a body 311a, and a second end 314a is fluidly attached to the second base section 308 at the first end 309a. In an exemplary example, the body 311a extends substantially perpendicular from the second base section 308, however, other examples can have the body 311a extend outwards from the second base section 308 at nearly any angle. The second end 314a fluidly connects to a first end 309b of a second conduit segment 316, thereby defining a conduit rotational interface 318 between the second end 314a and first end 309b. The conduit rotational interface 318 is situated along a second plane 320, which is parallel to the first plane 307. In an example, the first plane 307 and second plane 320 are also parallel to the mounting surface. In alternative examples, the first plane 307 and second plane 320 are perpendicular to the mounting surface.

Referring now to FIG. 4, an adjustable plumbing fixture is shown as a wall-mounted pot filler 400. The pot filler 400 has a mounting plate 402 configured to be mounted to a surface, such as a wall. A base section 404 extends substantially perpendicular from the mounting plate 402 and is configured to be in fluid communication with a water line. In some examples, the mounting plate 402 can be omitted and the base section 404 can extend straight from the wall surface. The base section 404 comprises an outlet portion 405 that extends from the base section 404. In an example, the outlet portion 405 extends substantially perpendicular from the base section 404, but in other examples the outlet portion 405 can extend from the base section 404 at almost any angle. Further, a first fluid adjustment knob 422 can be disposed on the base section 404. In one example, the fluid adjustment knob 422 can be disposed on an end of the base section 404 opposite the mounting plate 402 or mounting surface.

The outlet portion 405 is fluidly connected to a first end 409a of a first conduit segment 412. A first rotational interface 410 is formed where the first end 409a connects to the outlet portion 405, such that the first conduit segment 412 can rotate around the first rotational interface 410 and move relative to the base section 404 while maintaining fluid connection with the base section 404. The first rotational interface 410 defines a first plane 407. In an exemplary example, the first rotational interface 410 has a similar width or diameter as the base section 404 and outlet portion 405.

A second conduit segment 416, having a first end 409b, a body 411b, and a second end 414b is fluidly attached to the second end 414a of the first conduit segment 412. The second end 414a fluidly connects to the first end 409b of the second conduit segment 416, thereby defining a second rotational interface 418 between the second end 414a and first end 409b. The second rotational interface 418 is situated along a second plane 420, which is parallel to the first plane 407. In an example, the first plane 407 and second plane 420 are also parallel to the mounting surface. In alternative examples, the first plane 407 and second plane 420 are perpendicular to the mounting surface.

Referring to both FIGS. 3 and 4, in an example, the second end 314b, 414b of the second conduit segment 316, 416 comprises a spout. In other examples, the second end 314b, 414b of the second conduit segment 316, 416 attaches to a spout to provide further water dispensing options. For example, the second end 314b, 414b of the second conduit segment 316, 416 could be fluidly attached to a multi-mode spout or to a pull-down spout to allow even more flexibility in use. Further, a second fluid control knob 324, 424 can be disposed on the second conduit segment 316, 416 or the first conduit segment 314, 414. This might be beneficial, so a user can control water flow when the faucet 300, 400 is fully extended and the first fluid control knob 322, 422 is further away. The second fluid control knob 324, 424 may also increase safety by not requiring a user to reach over the top of a stove, for example.

In some examples, the bodies 311a, 411a and 311b, 411b can be comprised of multiple body pieces fluidly connected to each other through any method of water-tight connecting, such as threads, for example. Such a design may be desirable for manufacturability, so that curved and straight body pieces can be manufactured separately and later assembled together. In other examples, the bodies 311a, 411a and 311b, 411b can be comprised of a single body piece. Such a design may be desirable, for example, for certain aesthetic benefits. Further, the bodies 311a, 411a and 311b, 411b can be comprised of any length or curvature to reach the desired range of motion. In an example where the bodies 311a, 411a, and 311b, 411b, are comprised of multiple body pieces, it may be advantageous to allow a user to purchase additional or custom body pieces to create the desired range of motion in their personal space.

In an exemplary use, a user can place a pot in the sink or on the counter, stove, or floor. The user can pull or push the first conduit segment 312, 412, which would cause the faucet to rotate, spin, or move around the first or base rotational interface 310, 410. Further adjustment of range of motion can be achieved by pulling or pushing on the second conduit segment 316, 416. This would cause the second conduit segment 316, 416 to rotate, spin, or move around the conduit or second rotational interface 318, 418. Through this adjustment, a range of motion of the spout can be increased when needed, and then stored flat against a wall, or elsewhere out of the way, when it is not. Alternatively, a user could only pull the second conduit segment 316, 416, which would cause simultaneous rotation around the base or first rotational interface 310, 410 and conduit or second rotational interface 318, 418. Such a use would allow for a quick and smooth extension of the faucet range of motion. Once the spout is positioned over the pot, the user can control the water flow by using the first fluid control knob 322, 422 and second fluid control knob 324, 424. The first and second fluid control knobs 322, 422 and 324, 424 open and close valves, thus both must be opened for water to flow and only one must be closed for the water to stop.

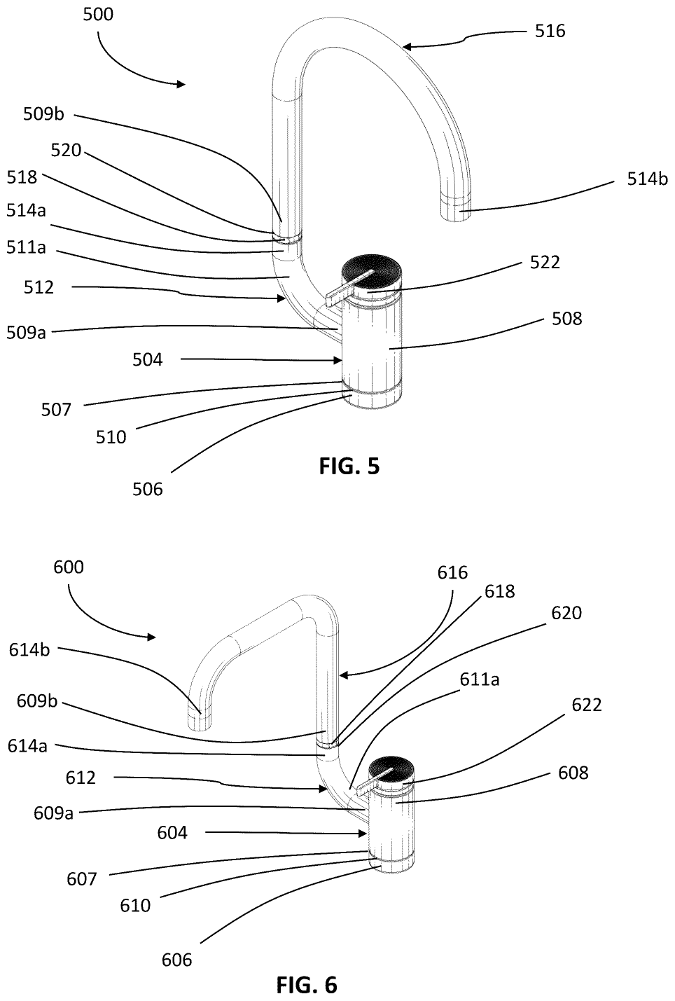

Referring now to FIGS. 5 and 6, two more examples of an adjustable plumbing fixture are shown as a single handle faucet 500, 600. The single handle faucet 500, 600 has a base section 504, 604 configured to be in fluid communication with a water line and mount to a surface, like a counter, sink, or wall such that the base section 504, 604 extends substantially perpendicular from the work surface. In other examples, a mounting plate can mount to the work surface and the base section 504, 604 can extend substantially perpendicular from the mounting plate. The base section 504, 604 is split into a first base section 506, 606 and a second base section 508, 608. The second base section 508, 608 can have a fluid control knob 522, 622 positioned on top. The fluid control knob 522, 622 is configured to remain stationary when the second base section 508, 608 rotates, as discussed below.

The first base section 506, 606 and the second base section 508, 608 are fluidly connected by a base rotational interface 510, 610. The base rotational interface 510, 610 allows the second base section 508, 608 to rotate, spin, or otherwise move, relative to the first base section 506, 606, while allowing the first base section 506, 606 and second base section 508, 608 to remain fluidly connected to each other. Further, the base rotational interface 510, 610 defines a first plane 507, 607. In one example, the base rotational interface 510, 610 does not exceed the width or diameter of the base section 504, 604.

A first conduit segment 512, 612, having a first end 509a, 609a, a body 511a, 611a, and a second end 514a, 614a is fluidly attached to the second base section 508, 608 at the first end 509a, 609a. In an example, the body 511a, 611a extends substantially perpendicular from the second base section 508, 608, however, other examples can have the body 511a, 611a extend outwards from the second base section 508, 608 at nearly any angle. Further, the body 511a, 611a can comprise an angle such that the first end 509a, 609a is on a different plane than the second end 514a, 614a. The second end 514a, 614a fluidly connects to a first end 509b, 609b of a second conduit segment 516, 616, thereby defining a conduit rotational interface 518, 618 between the second end 514a, 614a and first end 509b, 609b. The conduit rotational interface 518, 618 is situated along a second plane 520, 620, which is parallel to the first plane 507, 607. In an example, the first plane 507, 607 and second plane 520, 620 are also parallel to the mounting surface. In alternative examples, the first plane 507, 607 and second plane 520, 620 are perpendicular to the mounting surface.

In an example, the second end 514b, 614b of the second conduit segment 516, 616 comprises a spout. In other examples, the second end 514b, 615b of the second conduit segment 516, 616 attaches to a spout to provide further water dispensing options. For example, the second end 514b, 614b of the second conduit segment 516, 616 could be fluidly attached to a multi-mode spout or to a pull-down spout to allow even more flexibility in use.

In some examples, the bodies 511a, 611a and 511b, 611b can be comprised of multiple body pieces fluidly connected to each other. Such a design may be desirable for manufacturability, such that curved and straight body pieces can be manufactured separately and later assembled together. In other examples, the bodies 511a, 611a and 511b, 611b can be comprised of a single body piece. Such a design may be desirable, for example, for certain aesthetic benefits. Further, the bodies 511a, 611a and 511b, 611b can be comprised of any length or curvature to reach the desired range of motion. In an example where the bodies 511a, 611a and 511b, 611b, are comprised of multiple body pieces, it may be advantageous to allow a user to purchase additional or custom body pieces to create the desired range of motion in their personal space.

In an exemplary use, a user can place a vessel on the work surface, which can be the sink, counter, stove, or floor in various examples. The user can pull or push the first conduit segment 512, 612 which would cause the faucet to rotate, spin, or move around the first rotational interface 510, 610. Further adjustment of range of motion can be achieved by pulling or pushing on the second conduit segment 516, 616. This would cause the second conduit segment 516, 616 to rotate, spin, or move around the second rotational interface 518, 618. Through this adjustment, a range of motion of the spout can be increased when needed, and then stored flat against a wall, or elsewhere out of the way, when it is not. Alternatively, a user could only pull the second conduit segment 516, 616, which would cause simultaneous rotation around the first rotational interface 510, 610 and second rotational interface 518, 618. Such a use would allow for a quick and smooth extension of the faucet range of motion.

It is to be appreciated that further examples of the plumbing fixtures shown and described could be created from combining components in different arrangements and quantities to achieve different examples. For example, a third conduit section could be implemented with the addition of a third rotational interface that is parallel to the first and second rotational interfaces, to allow the spout to reach an even greater area. This disclosure lends itself to a modular ability of adding additional conduit sections of varying shapes and orientations to achieve a desired range of motion for the spout.

Further, it is to be appreciated that the Figures contained in this disclosure are examples. Other examples could be created, for example, by using and combining conduit segments that may have different shapes and angles than those specifically shown. Further, the conduit segments and base sections shown are cylindrical in shape. However, in other examples, these components may comprise a rectangular cross-section or share both rounded and angular features.

Additionally, the base rotational interface 110 (and those similarly numbered), can be located at any location on the on the base section 104. As shown in FIG. 1, the base rotational interface 110 can be located close to the mounting surface, or as shown in FIG. 3, the base rotational interface 310 can be located further from the mounting surface. The base rotational interface 110 can be located anywhere on the length of the base section 304. Further, in some examples the first conduit segment 112 (and those numbered similarly) can be connected to the first base section 106 and the base rotational interface 110 can be configured to allow the first base section 106 to rotate relative to the second base section 108.

It is also to be appreciated that the present disclosure encompasses a variety of manufacturing materials. The conduit segments, for example, may be comprised of stainless steel, polished brass, a polymer, or any material that provides a rigid and watertight structure. Additionally, the rotational interfaces can comprise radial or face sealing O-rings or gaskets to further prevent water from leaking. The rotational interfaces may also use friction reducing methods to allow the faucet to be adjusted with less resistance. Such methods, for example, may involve using bearings or a low coefficient of friction material, or both. In examples that further comprise a pull-down sprayer, a length of hose can also be disposed inside of the conduit segments and rotational interfaces.

The disclosure may be embodied in other specific forms without departing from the essential attributes. Therefore, the illustrated examples should be considered illustrative and not restrictive in all respects. Any claims provided herein are to ensure adequacy of the present application for establishing foreign priority and for no other purpose.

Various examples of systems, devices, and methods have been described herein. These examples are given only be way of example and are not intended to limit the scope of the claimed disclosures. It should be appreciated, moreover, that the various features of the examples that have been described may be combined in various ways to produce numerous additional examples. Moreover, while various material, dimensions, shapes, configurations, locations, etc. have been described for use with disclosed examples, others besides those disclosed may be utilized without exceeding the scope of the claimed disclosures.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood be persons of ordinary skill in the art. Moreover, elements described with respect to one example can be implemented in other examples even when not described in such examples unless otherwise noted.

Any incorporation of reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A directionally adjustable faucet, comprising:
a first base section;
a second base section coupled to the first base section;
a base rotational interface disposed between the first base section and the second base section along a first plane, the base rotational interface configured to actuate the second base section relative to the first base section;
a plurality of conduit segments operably coupled to the second base section; and
at least one conduit rotational interface disposed between the plurality of conduit segments along a second plane, the at least one conduit rotational interface configured to actuate the plurality of conduit segments relative to each other, wherein the second plane is parallel with the first plane.

2. The faucet of claim 1, wherein the plurality of conduit segments comprises two conduit segments and the at least one conduit rotational interface comprises one conduit rotational interface disposed between the two conduit segments, wherein one of the two conduit segments is directly coupled to the second base section.

3. The faucet of claim 2, wherein a conduit segment of the plurality of conduit segments is coupled to the second base section at a substantially right angle.

4. The faucet of claim 1, wherein the first base section and the second base section have the same or substantially the same cross-sectional shape and area.

5. The faucet of claim 1, wherein the second base section further comprises a fluid control knob configured to control fluid flow from the faucet.

6. The faucet of claim 1, wherein the first base section is coupled to a surface and the first plane is parallel to the surface.

7. The faucet of claim 1, wherein the first base section is coupled to a surface and the first plane is perpendicular to the surface.

8. The faucet of claim 1, wherein the plurality of conduit segments comprises a first conduit segment and a second conduit segment, wherein the first conduit segment is coupled to a first fluid control knob and the second conduit segment is coupled to a second fluid control knob, the first fluid control knob and the second fluid control knob each configured to control fluid flow from the faucet.

9. The faucet of claim 1, further comprising a pull-down sprayer coupled to a free end of the plurality of conduit segments.

10. The faucet of claim 1, wherein the first base section is coupled to a mounting plate.

11. A directionally adjustable primary or beverage faucet, comprising:
a base section;
an outlet portion coupled to the base section;
a plurality of conduit segments operably coupled to the outlet portion;
a first rotational interface disposed between the outlet portion and the plurality of conduit segments along a first plane, the first rotational interface configured to actuate the plurality of conduit segments relative to the base section; and
a second rotational interface disposed between the plurality of conduit segments along a second plane, the second rotational interface configured to actuate the plurality of conduit segments relative to each other, wherein the second plane is parallel with the first plane.

12. The faucet of claim 11, wherein the outlet portion is coupled to the base section at a substantially right angle.

13. The faucet of claim 11, wherein the base section is coupled to a mounting plate.

14. The faucet of claim 11, wherein the outlet portion and the plurality of conduit segments have the same or substantially the same cross-sectional shape and area.

15. The faucet of claim 11, wherein the base section further comprises a first fluid control knob configured to control fluid flow from the faucet.

16. The faucet of claim 11, wherein the first base section is coupled to a surface and the first plane is parallel to the surface.

17. The faucet of claim 11, wherein the first base section is coupled to a surface and the first plane is perpendicular to the surface.

18. The faucet of claim 11, further comprising a second fluid control knob coupled to a conduit segment of the plurality of conduit segments, the second control knob being configured to control fluid flow through the conduit segment.

19. The faucet of claim 11, further comprising a pull-down sprayer coupled to a free end of a conduit segment of the plurality of conduit segments.

20. A directionally adjustable primary or beverage faucet, comprising:
a first base section coupled to a second base section; and
a plurality of conduit segments operably coupled to the second base section,
wherein the second base section is configured to actuate relative to the first base section, and wherein the plurality of conduit segments are configured to actuate relative to each other.
